(19) United States
(12) Patent Application Publication
(10) Pub. No.: US 2010/0112291 A1
(43) Pub. Date: May 6, 2010

(54) METHOD FOR PRODUCTION OF POLYESTER RESIN FILM, AND POLYESTER RESIN FILM, ANTIREFLECTIVE FILM AND DIFFUSION FILM PRODUCED BY THE METHOD

(75) Inventors: Shinichi Nakai, Minami-Ashigara-Shi (JP); Masaaki Otoshi, Minami-Ashigara-Shi (JP); Yasuyuki Maki, Minami-Ashigara-Shi (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/593,118

(22) PCT Filed: Mar. 25, 2008
(86) PCT No.: PCT/JP2008/055559

§ 371 Date: Sep. 25, 2009

(30) Foreign Application Priority Data
Mar. 27, 2007 (JP) 2007-082008

(51) Int. Cl. B32B 3/28; B29C 47/88

(52) U.S. Cl. 428/156; 264/211.12

(57) ABSTRACT

A method for producing a polyester resin film includes melt extruding a polyester resin into a sheet shape, cooling and solidifying the polyester resin sheet on a casting drum, then longitudinally stretching the polyester resin sheet in the longitudinal direction, and then transversely stretching the longitudinally stretched polyester resin film in the transverse direction. The glass transition temperature of the polyester resin, Tg (° C.), the crystallinity of the film after the longitudinal stretching, Xc (%), the crystallization temperature of the film after the longitudinal stretching, Tc (° C.), film surface temperature at the entrance of the stretching zone of a transverse stretching apparatus 30, Ts (° C.), and film surface temperature at the exit of the stretching zone of the transverse stretching apparatus 30, Te (° C.), satisfy: 3≦Xc≦20; Tg−10≦Ts≦Tc+20; and Tc−10≦Te≦Tc+80.

### TECHNICAL FIELD

The present invention relates to a method for production of a polyester resin film, and particularly to a method for production of a polyester resin film in which thickness unevenness in the transverse direction is corrected and which has excellent transparency and is applied to optical use, a polyester resin film produced by this production method, and an antireflective film and a diffusion film using this polyester resin film for a substrate.

### BACKGROUND ART

In recent years, the spread of personal computers, particularly, the spread of notebook personal computers with good portability and space-saving desktop personal computers, has been significant. Also, liquid crystal televisions, as slim, big screen televisions for home use, are being spread. With these circumstances, demand for liquid crystal displays increases, and bigger screens are promoted.

As various optical films used for these, for example, an antireflective film is used to prevent that light, such as sunlight, is reflected from a television screen so that the screen is difficult to see. Also, a diffusion sheet is used for the backlight unit of a liquid crystal display to illuminate the front of the liquid crystal layer with light from the light source. The antireflective film and the diffusion film are both required to have excellent transparency to pass light from the backlight unit.

These optical films are formed by, after production, once winding a transparent support that is a substrate, then pulling out the transparent support again, and coating the transparent support with each layer. If thickness unevenness is present in the transparent support, particularly, thickness unevenness is present in the transverse direction, a difference in level is formed in the thick portion, for example, haze unevenness, streak unevenness, a flaw, and the like occur, when the support is wound, so that transparency may worsen. Also, a portion with large thickness unevenness is seen like a band, which is appearance failure in a wound form and is a problem. Also, if a flaw and the like occur so that transparency worsens, the flaw is visually recognized, and the brightness of the screen decreases, when the support is used for an optical film for a flat panel display (FPD), such as a crystal display (LCD) and a plasma display (PDP), which are problems.

In order to make the film thickness of the transparent support uniform to solve such problems, Patent Document 1 describes a method for producing a thermoplastic film from a melted resin discharged from a die, using a plurality of cooling drums, characterized in that the temperature of the surface of at least one cooling drum is controlled to be higher than the cooling drum upstream in a direction in which the thermoplastic film moves.

### Patent Document 1: Japanese Patent Application Laid-Open No. 2006-327160

### DISCLOSURE OF THE INVENTION

### Problems to be Solved by the Invention

However, in recent years, with the spread of notebook personal computers, liquid crystal televisions, and the like, increasingly higher quality has been required for optical films used for these. Therefore, suppression of thickness unevenness by the production method in Patent Document 1 has not been sufficient, and further improvement has been desired.

The present invention has been made in view of such a problem. It is an object of the present invention to provide a method for production of a polyester resin film in which occurrence of thickness unevenness in the transverse direction (TD) is suppressed, a polyester resin film produced by this production method, and an antireflective film and a diffusion film using this polyester resin film for a substrate.

### Means for Solving the Problems

In order to achieve the above object, the first aspect of the present invention provides a method for production of a polyester resin film comprising melt extruding a polyester resin into a sheet shape, cooling and solidifying the polyester resin sheet on a casting drum, then longitudinally stretching the polyester resin sheet in the longitudinal direction, and then passing the longitudinally stretched polyester resin film through a transverse stretching apparatus to transversely stretch the longitudinally stretched polyester resin film in the transverse direction, characterized in that the glass transition temperature of the polyester resin, Tg (° C.), the crystallinity of the film after the longitudinal stretching, Xc (%), the crystallization temperature of the film after the longitudinal stretching, Tc (° C.), film surface temperature at the entrance of a stretching zone of the transverse stretching apparatus, Ts (° C.), and film surface temperature at the exit of the stretching zone of the transverse stretching apparatus, Te (° C.), satisfy the following formulas.

3≦Xc≦20 (1)

Tg−10≦Ts≦Tc+20 (2)

Tc−10≦Te≦Tc+80 (3)

According to the first aspect, by temperature conditions in the stretching zone in which transverse stretching is performed, and crystallinity of the film after longitudinal stretching being in a predetermined range, hardening of the film in which thickness unevenness in the transverse direction (hereinafter also referred to as “TD thickness unevenness”) is corrected can be efficiently performed during stretching, while necking stretching that occurs at the early stage of transverse stretching is suppressed as much as possible. Necking stretching is a form of stretching in which necking occurs at one point, and stretching is performed while the necking propagates.

If the formula (1) is less than 3, due to insufficient crystallization, hardening of the film does not easily occur during stretching, and thickness unevenness is not easily corrected. If the formula (1) is more than 20, necking stretching occurs at the early stage of stretching, and thickness unevenness worsens.

If the formula (2) is less than Tg−10° C., the film is not sufficiently heated, so that the film itself is hard, necking stretching occurs at the early stage of stretching, and thickness unevenness worsens. If the formula (2) is more than Tc+20° C., the film is crystallized before stretching and becomes hard, so that necking stretching occurs at the early stage of stretching, and thickness unevenness worsens.

If the formula (3) is less than Tc−10° C., the film is not sufficiently crystallized during stretching, so that hardening of the film does not occur easily, and thickness unevenness is not easily corrected. If the formula (3) is Tc+80° C. or more, relaxation of the amorphous part proceeds excessively, so that the film is softened, and thickness unevenness is not easily corrected.

The second aspect of the present invention is characterized in that in the first aspect, a transverse stretching ratio, Y times, of the transverse stretching apparatus, and a film breaking limit, Z times, during transverse stretching satisfy the following formula.

Z−2≦Y≦Z−0.1 (4)

In the second aspect, the transverse stretching ratio is defined. In the production method of the present invention, by performing stretching up to near the breaking limit during transverse stretching, the effect of correcting thickness unevenness can be obtained at the maximum. If the formula (4) is less than (Z−2), thickness unevenness is not sufficiently corrected. If the formula (4) is more than (Z−0.1), due to disturbance and the like during film production, the film tears easily, so that production propriety is not obtained.

The third aspect of the present invention is characterized in that in the first or second aspect, a thickness unevenness of the film, after the transverse stretching, which is measured for a distance of 30 cm in a transverse direction at minute intervals is 3% or less of film thickness.

According to the third aspect, by the thickness unevenness of the film which is measured for a distance of 30 cm in a transverse direction at minute intervals being 3% or less of film thickness, a film without deformation and without appearance failure can be formed without forming a difference in level during winding.

The fourth aspect of the present invention is characterized in that in the first to third aspects, in winding the polyester resin film after the transverse stretching, a thickness of a wound roll is in the range of 100 mm or more and 500 mm or less, and winding tension is in the range of 0.1 N/mm² or more and 5 N/mm² or less.

According to the fourth aspect, by the thickness of the wound roll and the winding tension being in a predetermined range, the band-like appearance failure of the roll due to TD thickness unevenness during winding can be inconspicuous. By decreasing the thickness of the wound roll, the number of stacking films can be decreased, so that the band of the roll can be inconspicuous. If the thickness of the roll is thinner than 100 mm, a sufficient winding length of the roll is not obtained. If the thickness of the roll is thicker than 500 mm, the band of the roll begins to be conspicuous, therefore, such thickness is not preferred.

Also, by decreasing the winding tension, the band of the roll after winding can be inconspicuous. If the winding tension is less than 0.1 N/mm², the tension is too low, so that winding is displaced. If the winding tension is more than 5 N/mm², the band of the roll begins to be conspicuous.

The fifth aspect of the present invention is characterized in that in any of the first to fourth aspects, the polyester resin is a polyethylene terephthalate resin.

The fifth aspect is particularly effective when the polyester resin is a polyethylene terephthalate resin.

The sixth aspect of the present invention provides a polyester resin film produced by the production method according to any of the first to fifth aspects.

The seventh aspect of the present invention provides an antireflective film characterized in that the polyester resin film according to the sixth aspect is used for a substrate.

The eighth aspect of the present invention provides a diffusion film characterized in that the polyester resin film according to the seventh aspect is used for a substrate.

In the polyester resin film obtained by the production method of the present invention, a film having small TD thickness unevenness and uniform film thickness can be produced, so that a film in which appearance failure does not occur in a wound form can be produced. Also, there is no occurrence of haze unevenness, streak unevenness, a flaw, and the like due to a difference in level when the film is wound, so that transparency rarely worsens. Therefore, the film can be suitably used as the substrate of an optical film, particularly, as an antireflective film and a diffusion film.

### ADVANTAGES OF THE INVENTION

According to the present invention, by the crystallinity of the film after longitudinal stretching, and the temperature conditions in the transverse stretching apparatus being in a predetermined range, the thickness unevenness in the transverse direction of the film can be corrected. Therefore, a film having uniform film thickness can be produced, so that a polyester resin film without appearance failure in a wound form can be produced. Also, due to formation of a difference in level, haze unevenness, streak unevenness, a flaw, and the like occur, but according to the production method of the present invention, a film having uniform film thickness can be formed, so that a film without a difference in level and having good transparency can be produced.

### BRIEF DESCRIPTION OF THE DRAWINGS

FIG. 1 is a schematic view of an apparatus for production of a polyester resin film;

FIG. 2 is a schematic view of a longitudinal stretching machine that carries out a longitudinal stretching step;

FIG. 3 is a schematic view of a transverse stretching machine that carries out a transverse stretching step;

FIG. 4 is a view showing a polyester resin film after a winding step;

FIG. 5 is a view showing one example of a graph showing the relationship between heat quantity and temperature; and

FIG. 6 is a table showing the results of the examples.

### DESCRIPTION OF SYMBOLS

10 . . . film production step part
11 . . . die
12 . . . casting drum
20 . . . longitudinal stretching machine
23 . . . heating and stretching roll
24 . . . cooling and stretching roll
30 . . . transverse stretching machine
31 . . . tenter
32 . . . air blocking curtain
40 . . . winder
42 . . . winding roll (film)
1 . . . thickness of roll

### BEST MODE FOR CARRYING OUT THE INVENTION

The preferred embodiment of the method for production of a polyester resin film according to the present invention will be described below with reference to the accompanying drawings.

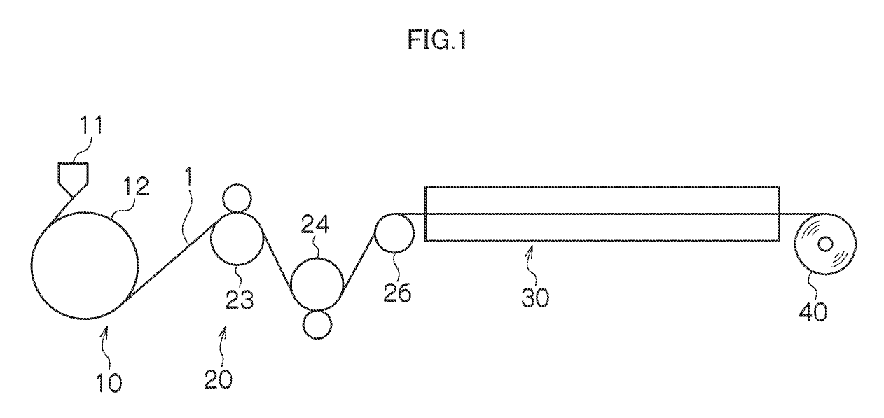

FIG. 1 is a view showing a schematic of an apparatus for production of a polyester resin film. In this view, reference numeral 10 designates a film production step part in which a polyester resin sheet is produced, reference numeral 20 designates a longitudinal stretching machine that stretches the polyester resin sheet, produced by this film production step part 10, in the longitudinal direction, reference numeral 30 designates a transverse stretching machine that stretches the longitudinally stretched polyester resin film, stretched in the longitudinal direction by the longitudinal stretching machine 20, in the transverse direction, and reference numeral 40 designates a winder that winds the polyester resin film stretched by the transverse stretching machine 30. In the film production step part 10, a die 11 and a casting drum 12 are provided, and the longitudinal stretching machine 20 is provided.

In the present invention, a film after the film production step and before the longitudinal stretching step is referred to as a “polyester resin sheet,” a film after the longitudinal stretching step is referred to as a “longitudinally stretched polyester resin film,” and a film after the transverse stretching step, that is, after biaxial stretching of longitudinal stretching and transverse stretching, is referred to as a “polyester resin film.”

### [Film Production Step]

First, the film production step will be described. A polyester resin is sufficiently dried, then melt extruded into a sheet shape through, for example, an extruder (not shown) in which temperature is controlled in the range of the melting point+10 to 50° C., a filter (not shown), and the die 11, and cast on the rotating casting drum 12 to be quenched and solidified so as to obtain a polyester resin sheet.

### [Longitudinal Stretching Step]

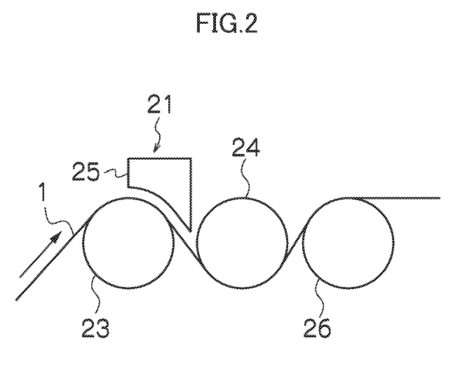

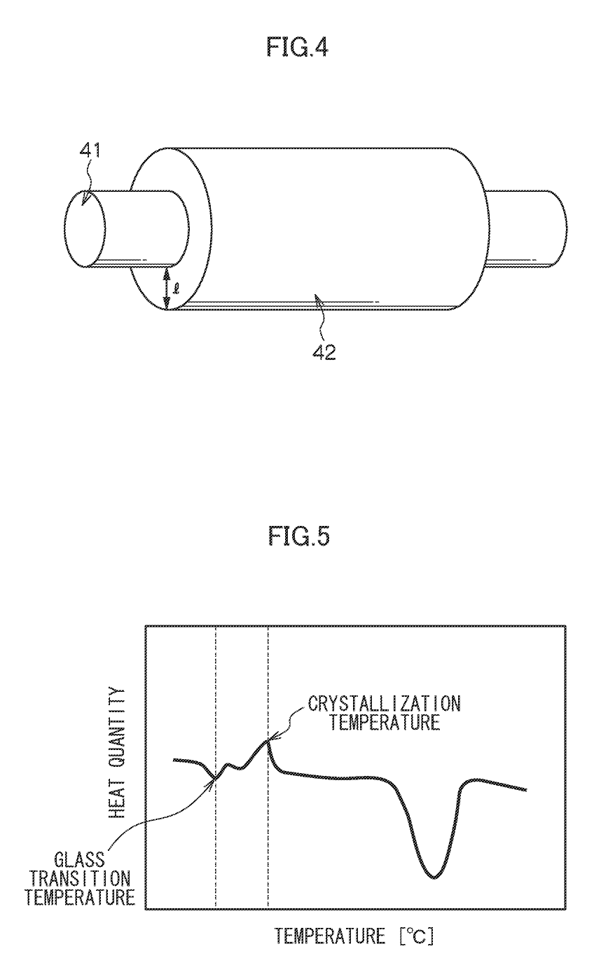

Next, the longitudinal stretching step will be described. The longitudinal stretching machine that carries out the longitudinal stretching step will be described with reference to FIG. 2. FIG. 2 is a schematic view of the longitudinal stretching machine. The longitudinal stretching machine is not limited to the apparatus described in FIG. 2, and an apparatus usually used for longitudinal stretching of a film can also be used. In FIG. 4, in the longitudinal stretching machine 20, a heating and stretching roll 23 and a cooling and stretching roll 24 having different peripheral speed are provided, and a far infrared heater (not shown) is provided above the heating and stretching roll 23. The unstretched polyester resin sheet is longitudinally stretched in the longitudinal stretching step, and then cooled to the glass transition point or less.

The longitudinal stretching step is performed by the longitudinal stretching machine as described above. In this longitudinal stretching step, the far infrared heater is used as means for heating the polyester resin film, and stretching is performed at a longitudinal stretching ratio of 1.5 to 4.5 times or less to obtain the longitudinally stretched polyester resin film.

The crystallinity of the film after longitudinal stretching, Xc, is 3% or more and 20% or less, preferably 4% or more and 18% or less, more preferably 5% or more and 15% or less, and further preferably 6% or more and 14% or less. By the crystallinity of the film after longitudinal stretching being in the above range, necking stretching can be suppressed, and hardening of the film in which thickness unevenness is corrected can be efficiently performed. If the crystallinity of the film after longitudinal stretching is less than 3%, due to insufficient crystallization, hardening of the film does not occur easily during stretching, and thickness unevenness is not easily corrected. If the crystallinity of the film after longitudinal stretching is more than 20%, necking stretching occurs at the early stage of stretching, so that thickness unevenness may worsen.

The crystallinity can be calculated from the density of the film. In other words, the crystallinity, Xc (%), can be derived from the following calculation formula, using the density of the film, X (g/cm³), density at a crystallinity of 0%, Yg/cm³, and density at a crystallinity of 100%, Zg/cm³.

Xc={Z×(X−Y)}/{X×(Z−Y)}×100

Measurement of density can be performed according to JIS K7112.

The longitudinally stretched polyester resin film that is longitudinally stretched under the particular conditions as described above is fed to the transverse stretching step and transversely stretched.

### [Transverse Stretching Step]

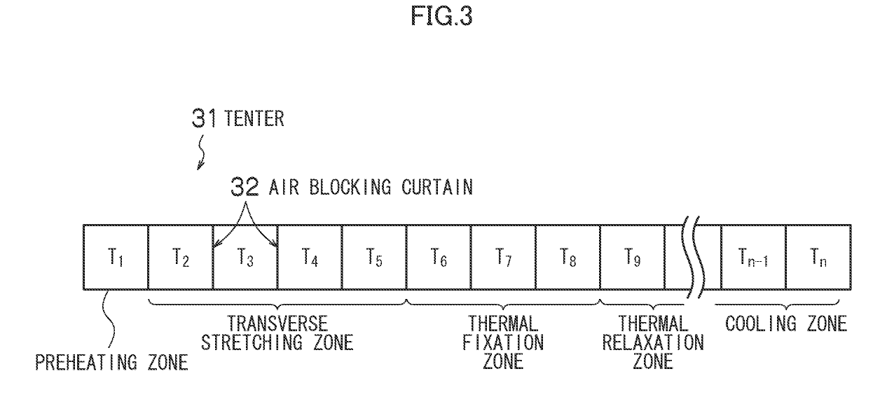

Next, the transverse stretching step will be described. The transverse stretching machine that carries out the transverse stretching step will be described with reference to FIG. 3. FIG. 3 is a schematic view of the transverse stretching machine. In FIG. 3, reference numeral 31 designates a tenter. This tenter 31 comprises many zones that can be individually temperature adjusted by hot air or the like and are divided by air blocking curtains 32, and a preheating zone T₁, transverse stretching zones T₂, T₃, T₄, and T₅, thermal fixation zones T₆, T₇, and T₈, thermal relaxation zones T₉ to Tₙ₋₃, and cooling zones Tₙ₋₂ to Tₙ, are located from the entrance.

The transverse stretching step is performed by the transverse stretching machine as described above. In the transverse stretching step, transverse stretching is performed by passing the longitudinally stretched polyester resin film in the tenter 31, and subjecting the longitudinally stretched polyester resin film to heat in the transverse stretching zones.

For the temperature of transverse stretching, transverse stretching is performed at a temperature that satisfies the following formulas (2) and (3) when the glass transition temperature of the polyester resin is Tg (° C.), the crystallization temperature of the film after longitudinal stretching is Tc (° C.), the film surface temperature at the entrance of the transverse stretching zone in the tenter 31 (the entrance of T₂ in FIG. 4) is Ts (° C.), and the film surface temperature at the exit of the transverse stretching zone (the exit of T₅ in FIG. 4) is Te (° C.).

Tg−10≦Ts≦Tc+20 (2)

Tc−10≦Te≦Tc+80 (3)

By the film surface temperature at the entrance of the transverse stretching zone, Ts, being in the range of the formula (2), transverse stretching can be performed, while necking stretching at the early stage of stretching is suppressed, and the film has moderate hardness. The film surface temperature at the entrance of the transverse stretching zone, Ts, is preferably Tg−5° C. or more and Tc+15° C. or less, more preferably Tg° C. or more and Tc+10° C. or less, and further preferably Tg+5° C. or more and Tc+5° C. or less. If the film temperature at the entrance is lower than Tg−10° C., the film is not sufficiently heated, so that the film is hard, necking stretching occurs at the early stage of stretching, and thickness unevenness worsens. If the film temperature at the entrance is more than Tc+20° C., the film is crystallized before stretching and becomes hard, so that necking stretching occurs at the early stage of stretching, and thickness unevenness worsens.

Also, by the film surface temperature at the exit of the transverse stretching zone, Te, being in the range of the formula (3), hardening of the film in which thickness unevenness is corrected can be efficiently performed. The film surface temperature at the exit of the transverse stretching zone, Te, is preferably Tc−5° C. or more and Tc+70° C. or less, more preferably Tc° C. or more and Tc+60° C. or less, and further preferably Tc+5° C. or more and Tc+55° C. or less. If the film temperature at the exit is lower than Tc−10° C., the film is not sufficiently crystallized during stretching, so that hardening of the film does not occur easily, and thickness unevenness is not easily corrected. If the film temperature at the exit is more than Tc+80° C., relaxation of the amorphous part proceeds, so that the film is softened, and thickness unevenness is not easily corrected.

Also, when the transverse stretching ratio in the transverse stretching step is Y times, the transverse stretching ratio, Y times, is preferably such that a film breaking limit, Z times, during transverse stretching satisfies the following formula.

Z−2≦Y≦Z−0.1 (4)

By performing stretching up to near the breaking limit during transverse stretching, the effect of correcting thickness unevenness can be obtained at the maximum. The transverse stretching ratio, Y, is preferably (Z−1.7) or more and (Z−0.3) or less, more preferably (Z−1.5) or more and (Z−0.4) or less, and further preferably (Z−1.3) or more and (Z−0.5) or less. If the transverse stretching ratio, Y, is less than (Z−2) times, thickness unevenness is not sufficiently corrected. If the transverse stretching ratio, Y, is more than (Z−0.1) times, due to disturbance during film production, the film tears easily, so that production is difficult. Therefore, such transverse stretching ratio, Y, is not preferred.

After transverse stretching in the transverse stretching zones, thermal fixation treatment is performed in the range of the melting point (Tm)−30° C. or more to the melting point (Tm)−5° C. or less, in the thermal fixation zones. If the thermal fixation temperature is less than the melting point (Tm)−30° C., the polyester resin film cleaves easily, so that breakage or the like occurs in processing in the subsequent steps, and the polyester resin film can not endure as an optical film. On the other hand, if the thermal fixation temperature is more than the melting point (Tm)−5° C., partial sagging occurs during film conveyance, which is a cause of scratch failure or the like, so that production stability is not good.

### [Winding Step]

The polyester resin film formed in the above manner is wound by a winder 40, and stored in the state of a wound roll (film) 42 wound around a winding core 41, as shown in FIG. 4. The polyester resin film produced by the production method of the present invention has small thickness unevenness in the transverse direction, which is not appearance failure when the polyester resin film is in a wound form. Also, a difference in level that occurs when thickness unevenness is present in the transverse direction is not formed, so that unevenness, a flaw, and the like do not occur in the film, and a film having good transparency can be produced.

The thickness of the roll in winding the film 1, is preferably 100 mm or more and 500 mm or less. Also, the winding tension is preferably in the range of 0.1 N/mm² or more and 5 N/mm² or less. By controlling the thickness of the wound roll 1, and the winding tension to be in the above range, the band-like appearance failure of the roll due to TD thickness unevenness can be inconspicuous.

By decreasing the thickness of the wound roll 1, the number of stacking films can be decreased, so that the band of the roll can be inconspicuous. If the thickness of the wound roll 1, is thinner than 100 mm, a sufficient winding length of the roll is not obtained, therefore, such thickness is not preferred. If the thickness of the wound roll 1, is thicker than 500 mm, the band begins to be conspicuous, therefore, such thickness is not preferred. The thickness of the wound roll 1, is more preferably 150 mm or more and 450 mm or less, and further preferably 200 mm or more and 400 mm or less.

Also, by decreasing the winding tension, the band of the roll can be inconspicuous. If the winding tension is weaker than 0.1 N/mm², the tension is too low, so that winding collapses, therefore, such winding tension is not preferred. If the winding tension is stronger than 5 N/mm², the band of the roll begins to be conspicuous, therefore, such winding tension is not preferred. The winding tension is preferably 0.2 N/mm² or more and 4 N/mm² or less, more preferably 0.4 N/mm² or more and 3.0 N/mm² or less, and further preferably 0.5 N/mm² or more and 2.0 N/mm² or less.

A method for measurement of the glass transition point, Tg (° C.), and the crystallization temperature of the film after longitudinal stretching, Tc (° C.), is shown below.

The glass transition point, Tg (° C.), can be measured using, for example, a differential scanning calorimeter, DSC-50 (manufactured by SHIMADZU CORPORATION). In the measurement method, 8 mg of pellets of a polyester resin previously weighed are set in a measurement apparatus, and the temperature is increased to 300° C. at a temperature increase rate of 10° C./min. The peak temperature of the glass transition point at this time is defined as glass transition temperature, and the glass transition point, Tg (° C.), can be obtained.

The crystallization temperature of the film after longitudinal stretching, Tc (° C.), can also be obtained by a similar measurement apparatus and method. In other words, 8 mg of the film after longitudinal stretching that is previously weighed are set in a measurement apparatus, and the temperature is increased to 300° C. at a temperature increase rate of 10° C./min. The temperature-increase crystallization peak temperature at this time is defined as crystallization temperature, and the crystallization temperature of the film after longitudinal stretching, Tc (° C.), can be obtained.

One example of a graph showing the relationship between heat quantity measured using a differential scanning calorimeter and temperature is shown in FIG. 5.

### [Polyester Resin Material]

Next, materials used for the method for production of a polyester resin film according to the present invention will be described. The polyester resin used in the present invention is obtained from diol and dicarboxylic acid by polycondensation. Dicarboxylic acid is represented by terephthalic acid, isophthalic acid, phthalic acid, naphthalenedicarboxylic acid, adipic acid, sebacic acid, and the like. Diol is represented by ethylene glycol, triethylene glycol, tetramethylene glycol, cyclohexanedimethanol, and the like. Specifically, for example, polyethylene terephthalate, polytetramethylene terephthalate, polyethylene-P-oxybenzoate, poly-1,4-cyclohexylene dimethylene terephthalate, polyethylene-2,6-naphthalene dicarboxylate, and the like can be listed, and polyethylene terephthalate is preferably used. These polyesters may be a homopolymer or may be a copolymer of monomers having different components or a blend. The copolymerization components include, for example, diol components, such as diethylene glycol, neopentyl glycol, and polyalkylene glycol, and carboxylic acid components, such as adipic acid, sebacic acid, phthalic acid, isophthalic acid, and 2,6-naphthalenedicarboxylic acid, and the like.

Publicly known catalysts can be used for esterification and transesterification respectively in production of the above polyester. Esterification proceeds even without particularly adding a catalyst, but transesterification requires time, so that the polymer should be maintained at high temperature for long time. As a result, there is inconvenience, for example, thermal degradation occurs. Then, by adding a catalyst as shown below, transesterification can proceed efficiently.

For example, as the catalyst for transesterification, manganese acetate, manganese acetate tetrahydrate, cobalt acetate, magnesium acetate, magnesium acetate tetrahydrate, calcium acetate, cadmium acetate, zinc acetate, zinc acetate dihydrate, lead acetate, magnesium oxide, lead oxide, and the like are generally used. These may be used alone or mixed.

The specific resistance of the melt extruded polyester resin is adjusted to 5×10⁶ to 3×10⁸ Ω·cm. If the specific resistance is less than 5×10⁶ Ω·cm, yellowness increases, and the occurrence of foreign substances increases, therefore, such specific resistance is not preferred. If the specific resistance is more than 3×10⁸ Ω·cm, the amount of air inclusion increases, so that roughness occurs in the film surface.

Adjustment of this specific resistance of the polyester resin is performed by adjusting the content of the above metal catalyst. Generally, as the metal catalyst content in the polymer is higher, transesterification proceeds faster, and the specific resistance value also decreases. But, if the metal catalyst content is too high, the metal catalyst is not uniformly dissolved in the polymer, which is a cause of occurrence of aggregated foreign substances.

Phosphoric acid and phosphorous acid and their esters, and inorganic particles (silica, kaolin, calcium carbonate, titanium dioxide, barium sulfate, alumina, and the like) may be contained in the polyester resin at the polymerization stage. Also, inorganic particles and the like may be blended in the polymer after polymerization. Further, a publicly known heat stabilizer, antioxidant, antistatic agent, lubricant, ultraviolet absorber, fluorescent brightening agent, pigment, light blocking agent, filler, and flame retardant, and the like may be added.

### [Polyester Resin Film]

In the polyester resin film produced by the above production method, the thickness unevenness of the film, after the transverse stretching, which is measured for a distance of 30 cm in a transverse direction at minute intervals is preferably 3% or less of film thickness, preferably 2.0% or less, more preferably 1.5% or less, and further preferably 1.0% or less. In the polyester resin film produced by the production method of the present invention, the phenomenon that the thickness unevenness in the transverse direction is corrected occurs during transverse stretching, so that the film with thickness unevenness in the above range can be produced.

The TD thickness unevenness is obtained by the following method. The film is cut out for 30 cm at any position in the transverse direction of the film, and thickness is measured for each 1 mm in the transverse direction. At this time, the maximum value of the thickness is Thmax, the minimum value is Thmin, and the average value is Thav. The TD thickness unevenness (%) is calculated from the following calculation formula.

TD thickness unevenness (%)=(Thmax−Thmin)/Thav×100

The polyester resin film produced by the production method of the present invention has small thickness unevenness in the transverse direction, so that when the polyester resin film is in a wound form, there is no appearance failure, and also, a difference in level does not occur. Therefore, a film without occurrence of unevenness and a flaw and having good transparency can be formed. Therefore, it can be suitably used as an optical film, particularly, an antireflective film and a diffusion film. The antireflective film is affixed to the front plate (optical filter) of a display, such as a cathode ray tube display (CRT), an LCD, and a PDP, to have the effect of utilizing light interference by the antireflective layer, suppressing the surface reflection and glare of the screen, and reducing reflected light. Also, the diffusion film is one of materials constituting a backlight for liquid crystal, and is a translucent film (sheet or plate) that scatters and diffuses light. The diffusion film is used to uniformly conduct light from the fluorescent tube to the front of the LCD.

### EXAMPLES

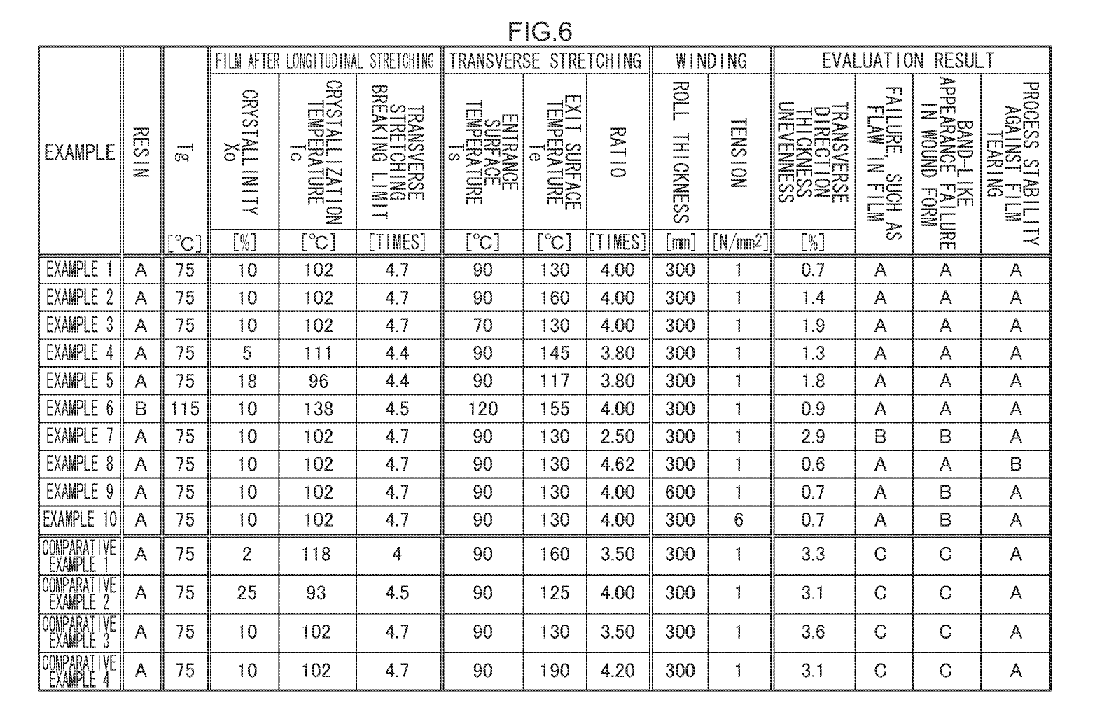

The substantial effect of the present invention will be described below by examples, but the present invention is not limited to these. The test conditions and results of the examples of the present invention are shown in FIG. 6. The raw material of a resin A in FIG. 5 is polyethylene terephthalate, and the raw material of a resin B is polyethylene naphthalate. Evaluation in FIG. 5 was performed according to the following standards.

### <Failure, Such as Flaw, and Band-Like Appearance Failure>

A . . . good
B . . . rather bad, but without actual damage, and within an allowable range
C . . . with actual damage

### <Process Stability Against Film Tearing>

A . . . good
B . . . rather bad, but without actual damage, and within an allowable range
C . . . with actual damage

For films in Examples 1 to 10, a sheet at a level of practically no problem was produced. But, in Example 7 with a low transverse stretching ratio, failure, such as a flaw in the film, and band-like appearance failure were recognized, and in Example 8 with a high transverse stretching ratio, the stability against film tearing during production was rather bad. But, they were within an allowable range. Also, in Example 9 in which the roll thickness during winding was thick, and in Example 10 with high winding tension, band-like appearance failure was recognized, though a little.

Also, in Comparative Examples 1 to 4 not satisfying the conditions of the formulas (1), (2), and (3), failure, such as a flaw, and band-like appearance failure in a wound form were recognized, and a film at a practical level could not be produced.

1-8. (canceled)

9. A method for production of a polyester resin film comprising melt extruding a polyester resin into a sheet shape, cooling and solidifying the polyester resin sheet on a casting drum, then longitudinally stretching the polyester resin sheet in a longitudinal direction, and then passing the longitudinally stretched polyester resin film through a transverse stretching apparatus to transversely stretch the longitudinally stretched polyester resin film in a transverse direction, characterized in that a glass transition temperature of the polyester resin, Tg (° C.), a crystallinity of the film after the longitudinal stretching, Xc (%), a crystallization temperature of the film after the longitudinal stretching, Tc (° C.), film surface temperature at an entrance of a stretching zone of the transverse stretching apparatus, Ts (° C.), and film surface temperature at an exit of the stretching zone of the transverse stretching apparatus, Te (° C.), satisfy the following formulas.
3≦Xc≦20 (1)
Tg−10≦Ts≦Tc+20 (2)
Tc−10≦Te≦Tc+80 (3)

10. The method for production of a polyester resin film according to claim 9, characterized in that a transverse stretching ratio, Y times, of the transverse stretching apparatus, and a film breaking limit, Z times, during transverse stretching satisfy the following formula.
Z−2≦Y≦Z−0.1 (4)

11. The method for production of a polyester resin film according to claim 9, characterized in that a thickness unevenness of the film, after the transverse stretching, which is measured for a distance of 30 cm in a transverse direction at minute intervals is 3% or less of film thickness.

12. The method for production of a polyester resin film according to claim 9, characterized in that in winding the polyester resin film after the transverse stretching, a thickness of a wound roll is in the range of 100 mm or more and 500 mm or less, and winding tension is in the range of 0.1 N/mm² or more and 5 N/mm² or less.

13. The method for production of a polyester resin film according to claim 9, characterized in that the polyester resin is a polyethylene terephthalate resin.

14. A polyester resin film produced by the production method according to claim 9.

15. An antireflective film characterized in that the polyester resin film according to claim 14 is used for a substrate.

16. A diffusion film characterized in that the polyester resin film according to claim 14 is used for a substrate.

17. The method for production of a polyester resin film according to claim 10, characterized in that a thickness unevenness of the film, after the transverse stretching, which is measured for a distance of 30 cm in a transverse direction at minute intervals is 3% or less of film thickness.

18. The method for production of a polyester resin film according to claim 17, characterized in that in winding the polyester resin film after the transverse stretching, a thickness of a wound roll is in the range of 100 mm or more and 500 mm or less, and winding tension is in the range of 0.1 N/mm² or more and 5 N/mm² or less.

19. The method for production of a polyester resin film according to claims 18, characterized in that the polyester resin is a polyethylene terephthalate resin.

20. The method for production of a polyester resin film according to claim 10, characterized in that a thickness unevenness of the film, after the transverse stretching, which is measured for a distance of 30 cm in a transverse direction at minute intervals is 3% or less of film thickness.

21. The method for production of a polyester resin film according to claim 10, characterized in that in winding the polyester resin film after the transverse stretching, a thickness of a wound roll is in the range of 100 mm or more and 500 mm or less, and winding tension is in the range of 0.1 N/mm² or more and 5 N/mm² or less.

22. The method for production of a polyester resin film according to claim 11, characterized in that in winding the polyester resin film after the transverse stretching, a thickness of a wound roll is in the range of 100 mm or more and 500 mm or less, and winding tension is in the range of 0.1 N/mm² or more and 5 N/mm² or less.

23. The method for production of a polyester resin film according to claim 10, characterized in that the polyester resin is a polyethylene terephthalate resin.

24. The method for production of a polyester resin film according to claim 11, characterized in that the polyester resin is a polyethylene terephthalate resin.

25. The method for production of a polyester resin film according to claim 12, characterized in that the polyester resin is a polyethylene terephthalate resin.

26. A polyester resin film produced by the production method according to claim 10.

27. A polyester resin film produced by the production method according to claim 11.

28. A polyester resin film produced by the production method according to claim 12.
